(19) United States
(12) Patent Application Publication
(10) Pub. No.: US 2017/0080267 A1
(43) Pub. Date: Mar. 23, 2017

(54) AIRCRAFT FIREFIGHTING SYSTEMS, EDUCTORS, AND METHODS OF USE

(71) Applicant: Wipaire, Inc., South St. Paul, MN (US)

(72) Inventors: Steven Wayne Wagner, Inver Grove Heights, MN (US); Jesse Reed Goebel, Cottage Grove, MN (US)

(21) Appl. No.: 14/861,274

(22) Filed: Sep. 22, 2015

(51) Int. Cl. A62C 3/02; A62C 35/02; A62C 5/00

(52) U.S. Cl. CPC A62C 3/0242; A62C 5/002; A62C 35/023

(57) ABSTRACT

An eductor includes inner and outer channels and a manifold region where these channels come together. The eductor has an outlet and inlets including a water inlet, a fire suppressant material inlet, and an air inlet. In certain embodiments, the eductor has mixing, rinse, and air purge configurations. In the mixing configuration, the eductor has both: i) a primary water flow path extending from the water inlet, through the outer channel, and into the manifold region, and ii) a fire suppressant flow path extending from the fire suppressant inlet, through the inner channel, and into the manifold region. In the rinse configuration, the eductor has a secondary water flow path extending from the water inlet, through the inner channel, and into the manifold region. In the air purge configuration, the eductor has an air flow path extending from the air inlet, though the inner channel, and into the manifold region.

### TECHNICAL FIELD

This disclosure relates generally to firefighting systems and, more particularly, to aircraft firefighting systems and eductors for mixing water with a fire suppressant material.

### BACKGROUND

Various tools and methods can be used to fight fires, such as wildfires. In some cases, an aircraft is used to discharge water over a fire. Water alone, however, may not be sufficient in fighting fires. It can be beneficial to mix one or more firefighting solutes with water before discharging the water over the fire. In some cases, for the firefighting solute and water to be effective in combating fire, the solute and water need to be thoroughly mixed together.

It would be desirable to provide a device for mixing a fire suppressant material and water to effectively combat fires. Moreover, it would be desirable to configure an aircraft to include such a mixing device so the aircraft can more effectively combat fires over long periods of time (e.g., by conducting multiple drops over a fire) before needing to return to a land base. Incorporating such a mixing device onto an aircraft, however, comes with complexities. These complexities include, for example, minimizing the weight and footprint of the mixing device/system so as to maximize the aircraft's capacity to hold water and the resulting mixture. Moreover, to allow the aircraft to continuously fight fires without needing to return to a land base, it would be desirable to have a reliable mixing device/system that is capable of prolonged operation. Such would be especially beneficial in fighting fires at remote locations. Some existing mixing devices, depending on how/where they are mounted, may be prone to malfunctions, such as internal blockage. This, for example, may be caused by a backflow of water from a nearby water container into the mixing device. If a mixing device were to become clogged during flight, this of course would hinder firefighting operations. Some existing mixing devices are limited in terms of where they can be mounted on an aircraft. It would therefore be desirable to provide a mixing device that can operate for prolonged periods without experiencing blockages, regardless of how/where it may be mounted relative to a water tank (e.g., below the water line of the water tank) on the aircraft. In addition, it would be desirable to provide a mixing device/system that provides and maintains thorough mixing of the water and the fire suppressant material.

### SUMMARY

In some embodiments, the invention provides a firefighting aircraft. One embodiment of the aircraft includes a fuselage and two floats that allow the aircraft to take-off from and land on bodies of water. The aircraft includes a water tank with a door having closed and open positions. The door when in the open position is configured to drop contents of the water tank from the aircraft. A first supply of fire suppressant material is located in one of the two floats. A first water scoop is adjacent to a bottom region of one of the two floats. A first water delivery line extends from the first water scoop to the water tank. The aircraft includes an eductor constructed (e.g., configured) to mix water from the water tank together with fire suppressant material from the first supply of fire suppressant material. A first feed line extends from the first supply of fire suppressant material to the eductor. A second water delivery line extends from the water tank, through the eductor, and back to the water tank. The aircraft also has a pump for moving water along the second water delivery line.

Certain embodiments of the invention provide an eductor to mix water together with a fire suppressant material. The eductor includes inner and outer channels that are concentric and a manifold region at a location where the inner and outer channels come together. The eductor includes a plurality of inlets and an outlet. The plurality of inlets includes a water inlet, a fire suppressant material inlet, and an air inlet. In the present embodiments, the eductor has a mixing configuration, a rinse configuration, and an air purge configuration. When in the mixing configuration, the eductor simultaneously has both: i) a primary water flow path extending from the water inlet, through the outer channel, and into the manifold region, and ii) a fire suppressant material flow path extending from the fire suppressant material inlet, through the inner channel, and into the manifold region. When in the rinse configuration, the eductor has a secondary water flow path extending from the water inlet, through the inner channel, and into the manifold region. When in the air purge configuration, the eductor has an air flow path extending from the air inlet, though the inner channel, and into the manifold region.

In another embodiment, the invention also provides an eductor to mix water together with a firefighting fire suppressant material. The eductor includes inner and outer channels that are concentric and a manifold region at a location where the inner and outer channels come together. The eductor includes a plurality of inlets and an outlet. The plurality of inlets includes a water inlet, a fire suppressant material inlet, and an air inlet. The eductor includes an inner tube and an outer tube. The inner tube bounds the inner channel. The outer channel is an annular channel located between the outer tube and the inner tube. In the present embodiment, the eductor further includes a shut-off plunger mounted for axial movement within the inner channel between a retracted position and an extended position. The shut-off plunger has a leading end region with a blocker head. The blocker head is configured such that when the shut-off plunger is in the extended position, the blocker head provides a barrier to water moving from the manifold region into the inner tube.

The details of one or more examples/embodiments are set forth in the accompanying drawings and the description below. Other features, objects, and advantages will be apparent from the description and drawings, and from the claims.

### BRIEF DESCRIPTION OF DRAWINGS

FIG. 1 is a side view of a fixed-wing firefighting aircraft in accordance with certain embodiments of the present invention.

FIG. 2 is a perspective view of an eductor to mix water together with a fire suppressant material in accordance with one embodiment of the invention.

FIGS. 3A and 3B are cross-sectional views of the eductor of FIG. 2 in a first configuration.

FIGS. 4A and 4B are cross-sectional views of the eductor of FIG. 2 in a second configuration.

FIGS. 5A and 5B are cross-sectional views of the eductor of FIG. 2 in third and fourth configurations, respectively.

FIG. 6 is a perspective view of an eductor to mix water together with a fire suppressant material in accordance with another embodiment of the invention.

FIG. 7 is a cross-sectional view of the eductor of FIG. 6 in a first configuration.

FIG. 8 is a cross-sectional view of the eductor of FIG. 6 in a second configuration.

FIG. 9 is a cross-sectional view of the eductor of FIG. 6 in a third configuration.

FIG. 10 a side view of an eductor to mix water together with a fire suppressant material in accordance with still another embodiment of the invention.

FIG. 11 is a cross-sectional view of the eductor of FIG. 10, with a shut-off plunger of the eductor shown in a retracted position.

FIG. 12A is a cross-sectional view of the eductor of FIG. 10, with the shut-off plunger of the eductor shown in an extended position.

FIG. 12B is a close-up perspective view of the shut-off plunger in the extended position of FIG. 12A.

FIG. 13 is a broken-away cross-sectional view of a float of the fixed-wing firefighting aircraft of FIG. 1.

FIG. 14 is a schematic cross-sectional view of a water-flow circuit that can be used on the fixed-wing firefighting aircraft of FIG. 1.

### DETAILED DESCRIPTION

The following detailed description is to be read with reference to the drawings, in which like elements in different drawings have like reference numerals. The drawings, which are not necessarily to scale, depict selected examples and are not intended to limit the scope of the invention. Skilled artisans will recognize that the given examples have many useful alternatives, which fall within the scope of the claims.

Aircraft are generally configured to operate from either ground landing strips or water landing strips (lakes, rivers, oceans, or other bodies of water) during takeoff and landing operations. In the case of amphibious aircraft, which include both floatation equipment and ground landing equipment, the aircraft can operate from both ground landing strips and water landing strips at the option of the operator. Such an aircraft provides increased flexibility because it is not confined to ground landing strips. It is, of course, not safe to land on water with an aircraft designed only for ground landings.

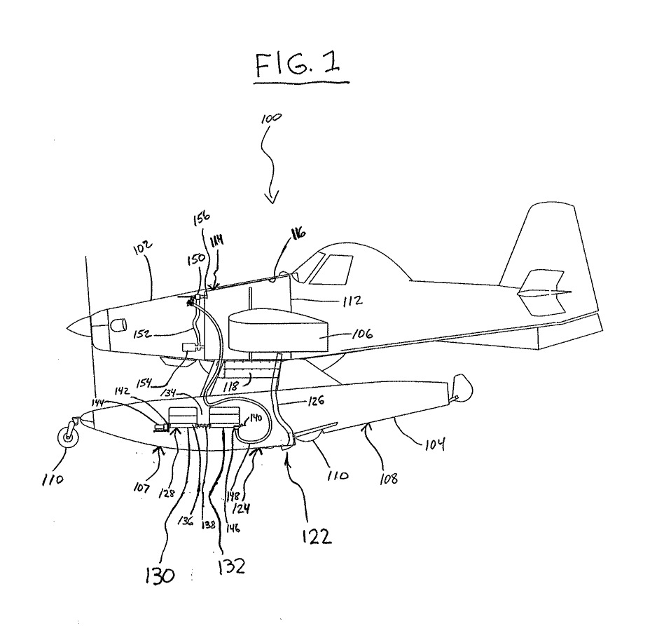

FIG. 1 shows a side view of a fixed-wing firefighting aircraft 100 that can be used as an amphibious aircraft in accordance with one embodiment of the present invention. In other embodiments, the aircraft may be configured only for water landings (i.e., the floats may be devoid of ground landing wheels). The aircraft 100 has a fuselage 102. In some cases, the fuselage 102 has a length of twenty feet or more, such as between 20 and 45 feet, or between 45 and 75 feet. In the illustrated embodiment, mounted to the fuselage 102 are two floats 104 and two fixed-wings 106. In the side view of FIG. 1, only a first float and a first wing can be seen, but as will be appreciated, a second float and a second wing are present on the opposite side. In some embodiments, the aircraft is a propeller-driven aircraft. The aircraft can be, for example, an Air Tractor AT-802F “Fire Boss,” which is equipped with amphibious floats from Wipaire, Inc., of South Saint Paul, Minn., U.S.A. The Fire Boss aircraft is available commercially from Wipaire and Air Tractor, Inc., of Olney, Tex., U.S.A.

The illustrated aircraft type is merely exemplary. Various types of aircraft can benefit from the present invention. Thus, the aircraft 100 can have different types of floats (e.g., of various sizes, shapes, and materials) mounted to the fuselage 102 and/or to wings 106. As one example, the aircraft may include sponsons. The aircraft may be larger (e.g., having a fuselage length of more than 75 feet), it may be jet powered, or both. More generally, it is to be appreciated that the invention extends to any aircraft into which the present eductor system can be incorporated beneficially.

Each of the floats 104 can be mounted to the fuselage 102 such that an elongated length of each float 104 is substantially parallel to the length of the fuselage 102, as shown in FIG. 1. The floats 104 may each have (or “define”) a leading half 107 and a trailing half 108. In addition, each float 104 can optionally include one or more retractable wheels 110, which when extended serve as ground landing equipment. The floats 104 and optional wheels 110 on the illustrated aircraft 100 allow it to operate as an amphibious aircraft, i.e., an aircraft equipped for (and hence capable of) both ground and water takeoff and landing operations. Thus, when an operator approaches a body of water, the wheels 110 are retracted such that the floats 104 alone define the contact points with the body of water.

The aircraft 100 includes a water tank 112. In the embodiment of FIG. 1, the water tank 112 is incorporated into (e.g., disposed inside) the fuselage 102. The water tank 112 can be used to hold various contents useful for fighting fires, such as water, fire suppressant material, and mixtures thereof. The illustrated water tank 112 has a top end region 114 that defines a maximum water line 116. In FIG. 1, the maximum water line 116 of the water tank 112 is adjacent to a top of the fuselage 102. The water tank 112 can include a door (e.g., a Bombay door) 118, which preferably is at the bottom end region of the water tank 112. The door 118 can be actuated between a closed position and an open position. When in the open position, the door 118 is configured to drop the contents of the water tank 112 from the aircraft 100. For example, an operator can open the door 118 (e.g., by operating an actuator in the cockpit of the aircraft) to drop the contents of the water tank 112 when the aircraft is flying over a fire. As noted above, the door 118 can be a Bombay door, which has two door halves configured to simultaneously open away from each other so as to drop the contents of the water tank 112. The illustrated door 118 is adjacent to the bottom of the fuselage. In the embodiment illustrated, the door 118 is spaced above the floats, as shown in FIG. 1. Thus, if desired, the door can be opened when the aircraft 100 is not in flight (e.g., while the aircraft is floating on a body of water, skimming along a body of water, resting on the ground, or travelling along the ground), so as to empty the contents of the water tank 112.

In the embodiment of FIG. 1, the aircraft 100 has only a single water tank 112 configured to drop water on fires during flight. In other embodiments, however, there can be two water tanks in the fuselage. For example, the aircraft can alternatively have two water tanks configured to receive water from two water delivery lines extending respectively from two scoops located respectively on the two floats. If desired, three or more water tanks (e.g., four tanks) can be provided. The aircraft's 100 center of gravity preferably is located at the water tank 112.

In some embodiments, the water tank 112 has one or more (e.g., a plurality of) agitators 120 in communication with an internal volume of the water tank 112. Reference is made to FIG. 14. The one or more agitators 120 can be positioned (e.g., can each comprise a nozzle oriented) to deliver one or more streams of water (e.g., pressurized streams of water, or “water jets,” as shown by arrow 850) into the water tank 112. This can help keep the water and fire suppressant material in the water tank 112 appropriately mixed. Preferably, the one or more agitators 120 are positioned to receive water from the water tank 112 and return such water (through the agitators) back into the water tank as one or more pressurized streams 850. This can be appreciated by referring to FIG. 14, where a water-flow circuit is configured to deliver water out of the water tank, through a water line section or intake 113 (which preferably forms an initial stage of water deliver line 152) extending from the water tank to the pump, then along water delivery line 152 to a branching point, from where water delivery line 152 and a branch line 153 diverge, such that water delivery line 152 extends to the eductor 150 while the branch line 153 extends to an agitator 120, which is positioned to deliver a pressurized stream of water 850 into the water tank 112. The pump 154 moves water from the water tank 112 along this water-flow circuit. Thus, some of the water traveling along water delivery line 152 is diverted along the branch line 153, which delivers such water to an agitator 120 that is positioned to deliver a pressurized stream of water 850 into the water tank 112. The rest of the water flowing through water delivery line 152 is delivered to the water intake of the eductor 150. It is to be appreciated that the water tank 112 may be equipped with a plurality of agitators 120.

When provided, the one or more agitators 120 preferably mix and/or help prevent settling of certain contents of the tank. For example, the agitator(s) 120 can optionally be positioned and oriented to circulate the contents of the water tank 112. In other cases, the agitator(s) 120 can simply be positioned and oriented to agitate the contents of the water tank (e.g., by creating one or more regions of rapid flow, which in some cases may include turbulent flow).

For purposes of delivering water to the water tank 112, the aircraft 100 can include a water scoop 122 adjacent to a bottom region 124 of a float 104. Preferably, the water scoop 122 is a retractable scoop, which has an extended position and a retracted position, and is movable therebetween. When the water scoop 122 is in the retracted position, it is substantially housed within a recess defined in the bottom region 124 of the float 104. When the water scoop 122 is in the extended position, it projects downwardly from the bottom region 124 of the float 104. A first water delivery line 126 can extend from such water scoop 122 (at a first end of the line) to the water tank 112 (at a second end of the line). This water delivery line 126 may be configured to deliver water to the bottom end region of the water tank 112.

Typically, a second retractable water scoop will be incorporated into the second float and placed in communication with the water tank 112 (or with a second tank, if provided) via a further water delivery line. Thus, in some cases, two water delivery lines extending respectively from the two floats both deliver water to a single water tank 112, which preferably is located within the fuselage. More generally, the description in the preceding paragraph about the illustrated float 104, water scoop 122, and water deliver line 126 also apply to the second water scoop.

In an alternate embodiment, the water tank is not inside the fuselage, but rather is located beneath the fuselage (e.g., mounted to the bottom of the fuselage). In other cases, it may be possible to mount one water tank beneath each wing.

When an operator wishes to fill the water tank 112 (e.g., after having already dropped the contents of the water tank at least once), the water scoop 122 can be actuated, e.g., moved to the extended position. The aircraft 100 can then be maneuvered so as to skim the surface of a body of water such that the extended water scoop 122 contacts the body of water. Doing so can cause the extended water scoop 122 to capture water from the body of water and move it into the water delivery line 126. The water delivery line 126 can deliver water from the scoop 122 to the water tank 112. In FIG. 1, the water delivery line 126 extends between the scoop 122 and the water tank 112 without being connected therebetween to the eductor 150 (which is described below).

As noted above, there will typically be two water scoops (one on each float). Thus, the foregoing description of a water scoop 122 and a water delivery line 126 applies for each/both of the two water scoops and each/both of the two water delivery lines. Accordingly, the aircraft 100 will typically include a second retractable water scoop (as part of the second float), and both water scoops will be extended simultaneously so as to fill the water tank (or tanks, as the case may be) while the aircraft 100 skims a body of water.

Once the water tank 112 is filled to a desired level (optionally to the maximum water line), the scoop 122 can be moved to the retracted position. Typically, the aircraft 100 will have two scoops, and each will be moved to the retracted position after filling the water tank or tanks.

The aircraft 100 can repeatedly drop the contents of the water tank (or tanks) and refill at a nearby body of water without needing to land at a ground base to refill the water tank after each drop. This is particularly beneficial in cases where the fire is at a location remote from the nearest ground base.

In some cases, dropping only water (i.e., pure water) from the water tank 112 onto a fire may not be sufficiently effective in fighting fires. Thus, it may be beneficial to add to the water tank 112 one or more additional contents (e.g., a fire suppressant material) that can act in conjunction with the water to better extinguish, suppress, or resist fire. The aircraft 100 therefore includes at least one supply of fire suppressant material. The supply (or supplies) of fire suppressant material can, for example, be housed in (e.g., disposed inside one or more refillable compartments of) one or two floats 104 of the aircraft. A delivery system (e.g., comprising one or more delivery lines) preferably extends from the supply (or supplies) of fire suppressant material to the water tank 112 (or water tanks) via one or more eductors 150. Suitable fire suppressant materials are commercially available (e.g., under the trade name TetraKO™) from Earth Clean Corporation of South St. Paul, Minn., U.S.A. Other suitable fire suppressant materials are commercially available (e.g., under the trade name PHOS-CHEK™) from ICL PERFORMANCE PRODUCTS LP of Rancho Cucamonga, Calif., U.S.A. Still other suitable fire suppressant materials are commercially available (e.g., in powder form, under the trade name FireIce™) from GelTech Solutions, Inc. of Jupiter, Fla., U.S.A.

In some embodiments, the aircraft 100 includes a hopper 128, which can be used to hold a powder (e.g., a firefighting solute) or another material useful for mixing with water to suppress fire. Thus, the hopper 128 may contain (e.g., may be filled with) powder. The hopper 128 can be located, for example, within a float 104, as shown in FIG. 1. In the illustrated example, the hopper 128 is positioned within the float 104 on the leading half 107 of the float 104. In other examples, the hopper 128 is positioned at other locations (e.g., within the fuselage 102 forward or aft of the water tank 112).

The illustrated hopper 128 includes first and second hopper tanks 130, 132. This is best shown in FIG. 13. The first and second hopper tanks 130, 132 can be configured to respectfully retain first and second volumes of powder. In some cases, the volumes of the first and second hopper tanks are the same. This, however, is not required. When provided, the hopper(s) 128 preferably are sealed within the float(s) 104, e.g., such that water outside the float is prevented (e.g., entirely, or at least substantially) from flowing into the powder hopper(s). Thus, the float(s) preferably define water-tight enclosures (or at least substantially water-tight enclosures) in which the powder or other fire suppressant material is located.

In the embodiment of FIG. 13, the areas of the powder hopper 128 in which the fire suppressant material (e.g., powder) is disposed is separated by one or more air spaces 131, such that the powder hopper 128 is spaced apart from the bottom of the float.

The first and second hopper tanks 130, 132 can optionally be separated by an intermediate float compartment 134. The intermediate float compartment 134 can be a hollow cavity (e.g., comprising an air space), which preferably contains no powder or other fire suppressant material.

In the illustrated embodiment, an auger conduit 136 (e.g., in the form of a tube) extends through the first hopper tank 130, through the intermediate float compartment 134, and through the second hopper tank 132. The auger conduit 136 is configured to deliver powder from the first hopper tank 130, through the intermediate float compartment 134, and into the second hopper tank 132. An auger 138 having a first end 142 and second end 140 can be disposed at least partially within the auger conduit 136. The auger 138 can extend from the first hopper tank 130, through the intermediate float compartment 134, and through the second hopper tank 132. The powder hopper 128 can include a drive mechanism 144 coupled to the first end 142 of the auger 138 and configured to rotate the auger 138. As a result, when powder is located in the first hopper tank 130, the auger 138 can be rotatably driven to convey powder from the first hopper tank 130 to the second hopper tank 132. The drive mechanism 144 can be a motor, such as the 33-WX Series Parallel Shaft DC Gearmotor Model 1214 that is commercially available from the Bodine Electric Company of Northfield, Ill., U.S.A.

The illustrated hopper 128 includes an outlet 146. In the example shown, the outlet 146 opens out from the second hopper tank 132 and is adjacent to the second end 140 of the auger 138. A feed line 148 is connected to the outlet 146 so as to convey powder (or another fire suppressant material) from the hopper 128. The feed line 148 can, for example, convey powder from the second hopper tank 132 until a volume of powder within the second hopper tank is substantially drawn. At such time, the drive mechanism 144 can be actuated so as to convey powder via the auger 138 from the first hopper tank 130 to the second hopper tank 132, where the powder can continue to be drawn by the feed line 148. Perhaps more preferably, the auger can be operated continuously during operation of the eductor(s) 150. The feed line 148 can extend from the outlet 146 (at a first end of the feed line) to the eductor 150 (at a second end of the feed line) so as to convey powder or another fire suppressant material from the hopper 128 to the eductor 150. Typically, the second float includes a second hopper (which can be configured in the same manner as the first hopper 128) so as to convey additional powder to a single eductor 150 on the aircraft 100. In other embodiments, two eductors are provided, and each one is operatively coupled with one of two hoppers located respectively in the two floats.

Regardless of the nature of the supply of fire suppressant material (e.g., whether or not it comprises a powder hopper), the aircraft preferably has a feed line extending between a supply of fire suppressant material (which is preferably located in a float) and the eductor 150 without being connected therebetween to the water tank 112. Typically, the aircraft will have two such feed lines extending respectfully from two supplies of fire suppressant material (which preferably are located respectfully in the two floats) and the eductor 150 without being connected therebetween to the water tank 112.

Preferably, the system is configured such that the eductor 150 is operable (i.e., to mix water and fire suppressant material and deliver the resulting mixture to the water tank 112) at any time during a flight mission when there is water in the tank 112, including when the aircraft is fully airborne (i.e., flying through the air and not skimming a body of water). The system can advantageously be configured such that the pump 154 and eductor 150 are operable for an extended period of time (e.g., at least 1 minute, at least 5 minutes, at least 10 minutes, or more) during the flight of the aircraft. Preferably, the system is capable of being operated (i.e., to mix water and fire suppressant material and deliver the resulting mixture to the water tank) continuously during flight. It is to be appreciated, however, that it is not necessary to run the system continuously. For example, different operators may wish to run the system differently, and different fire suppressant materials may benefit from different mixing protocols.

The eductor 150 is constructed to mix fire suppressant material (e.g., powder from hopper 128) together with water from the water tank 112. Water from the water tank 112 can be moved to the eductor 150 via a water delivery line 152. The water delivery line 152 extends from the water tank 112 (at a first end of the line) through the eductor 150 and back into the water tank 112 (at a second end of the line). In the embodiment shown, an outlet 156 of the eductor 150 opens out directly to the water tank 112. Thus, the outlet 156 of the illustrated eductor 150 defines the second end of water deliver line 152.

In other cases, a section of pipe or the like extends from the outlet 156 of the eductor 150 to the water tank 112. For example, an extension pipe 712 having a length of at least 3 inches, at least 6 inches, at least 12 inches, or at least 18 inches (such as about 24 inches) can be used in some cases. When provided, the extension pipe extends from the outlet 156 of the eductor 150 to the water tank 112. The extension pipe may have a narrowing region (e.g., a funnel region), which prevents the water from hugging to the wall of the pipe. Alternatively, there can be a small inwardly turned lip or some other reducer configuration that serves this function.

Regardless of the particular configuration of the outlet 156 and any extension pipe or the like projecting therefrom, the eductor 150 preferably is configured such that the mixture of water and fire suppressant material flowing from the outlet 156 prevents formation of a continuous column of air extending between the ambient air adjacent to the eductor outlet (or any extension pipe or the like extending therefrom) and an inner channel of the eductor. In more detail, the eductor 150 preferably is configured such that the mixture of water and fire suppressant material flowing from the outlet 156 creates at least one flow region where water entirely (or at least substantially entirely) fills the passage inside the eductor outlet or any extension pipe or the like extending therefrom. This is desirable for establishing inside the eductor 150 a vacuum that sucks the fire suppressant material from the hopper 128 (or other fire suppressant material supply), through the feed line 148, and into the eductor 150.

A separate pump is not necessary to move the fire suppressant material (e.g., powder from the hopper 128) to the eductor 150. Rather, the eductor itself is configured to draw (e.g., suck) the fire suppressant material (e.g., powder from the hopper 128) from the supply of fire suppressant material to the water tank 112. Specifically, the eductor 150 can use the water, pumped rapidly through the eductor via the pump 154, as a motive fluid that creates a vacuum to suck the fire suppressant material (e.g., powder from the powder hopper 128) from the supply of fire suppressant material in the float(s) to the eductor 150. Thus, the illustrated system is devoid of a pump positioned to move the fire suppressant material from the hopper 128 or other source, along the feed line 148, and into the eductor 150.

To move water along the water delivery line 152 from the water tank 112 and through the eductor 150, a pump 154 is provided. In FIG. 1, the pump 154 is located within the fuselage 102 of the aircraft 100. In the illustrated embodiment, the pump 154 is located within the fuselage 102 forward of the water tank 112, although other locations are possible as well. In one alternative, the pump is mounted below the belly of the fuselage. In such cases, the pump may be air driven.

In the embodiment of FIG. 1, the eductor 150 is located within the fuselage 102 and is in fluid communication with the water tank 112. Here, the eductor 150 is mounted below the maximum water line 116 of the water tank 112. Thus, the outlet 156 of the eductor 150 can optionally be located, at least in part, closer to the floats 104 than is water at the maximum water line 116 of the water tank 112. Thus, the outlet 156 of the eductor 150 may be in fluid communication with the top end region 114 of the water tank 112. As a result, water from the tank 112 may have an open passage to move (by back-streaming, water shifting, splashing, etc.) from the water tank 112 into the outlet 156 of the eductor 150. As noted above, the outlet 156 of the eductor 150 (or an extension thereof) can optionally project into (e.g., so as to be inside of) the water tank 112.

The aircraft 100 can include various systems for powering the devices described herein. For example, the aircraft can have a conventional hydraulic system, and it can be configured to drive the pump 154. Thus, the pump 154 can be a hydraulic pump that is connected to (e.g., driven by) a hydraulic system of the aircraft. Alternatively, the pump 154 can be air driven, or driven by an electric motor. Preferably, the pump 154 is configured to establish a pressurized water flow of at least 30 psi (such as 30-80 psi) through the eductor 150. In some cases, the pump 154 is configured to establish a pressurized water flow of at least 40 psi (such as 40-100 psi) through the eductor 150. In one non-limiting example, the pump 154 is used to establish a pressurized water flow of about 50 psi through the eductor 150.

The aircraft's hydraulic system may be used to actuate other components of the aircraft. Additionally or alternatively, the aircraft can include electronic systems and/or mechanical systems to actuate its various components, such as drive mechanism 144, retractable scoop 122, door 118, and/or retractable wheels 110.

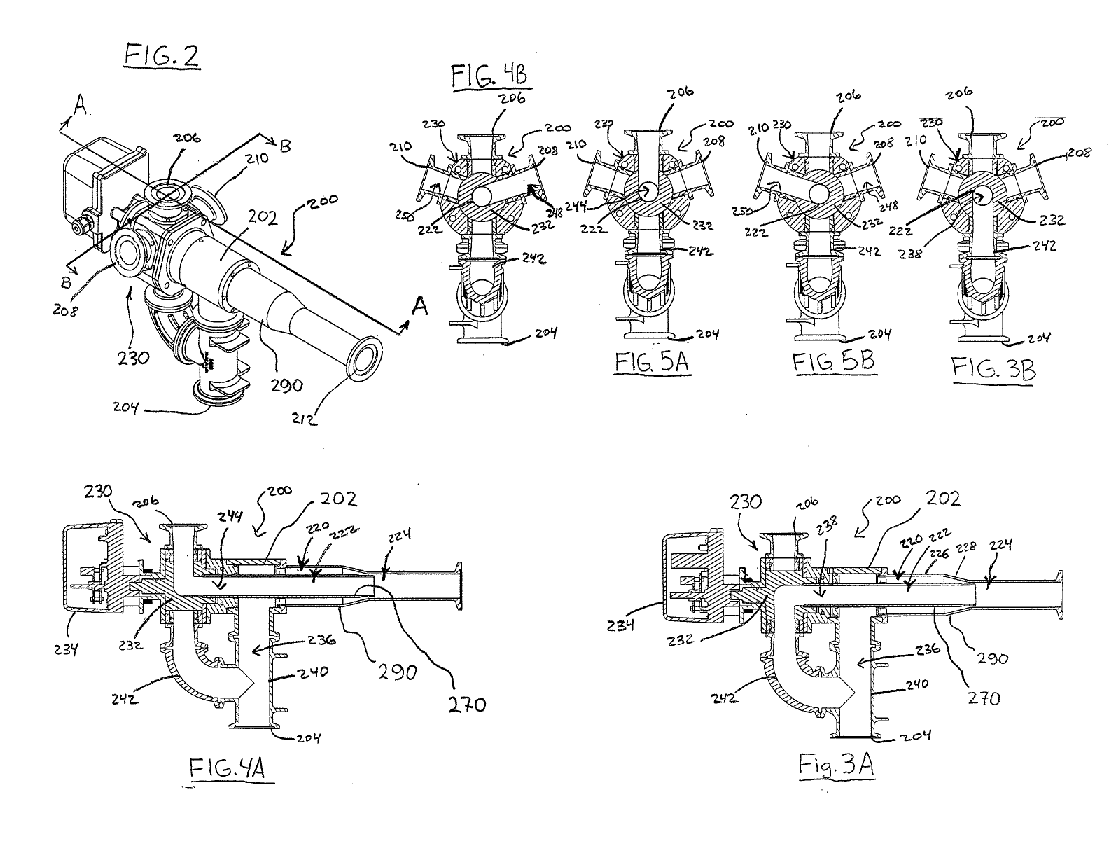

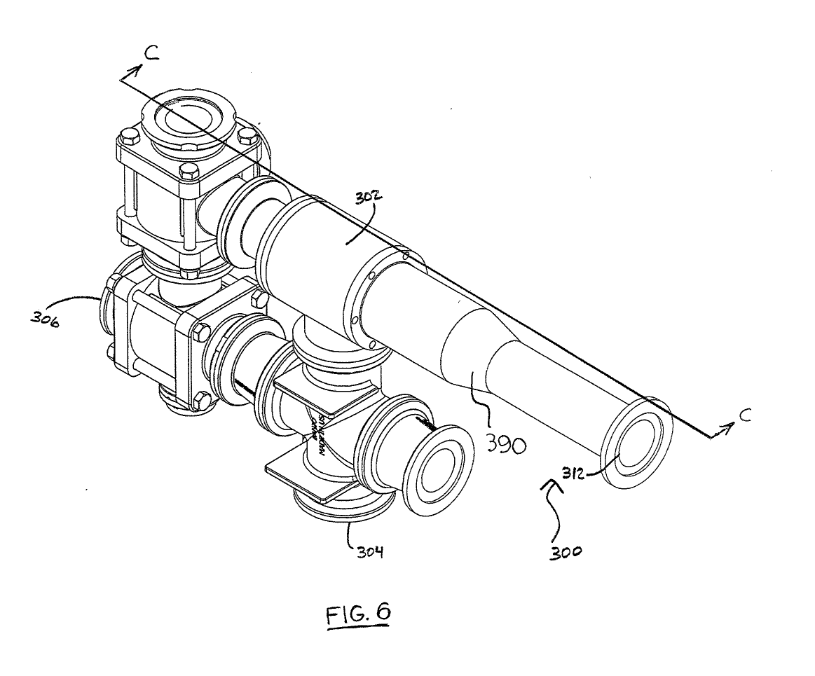

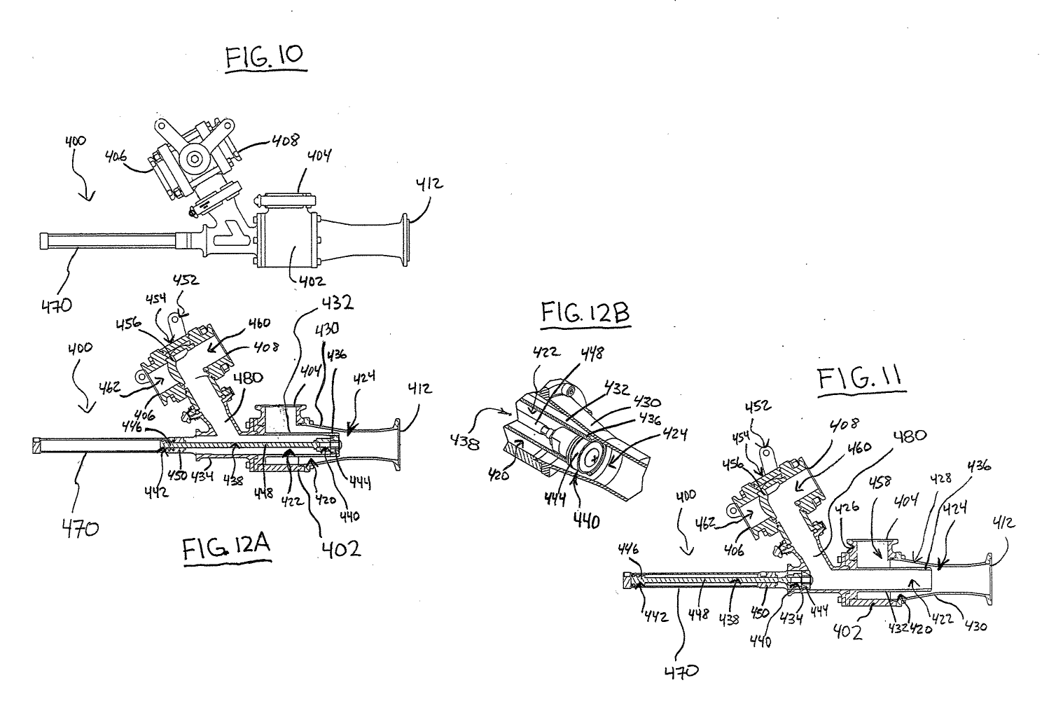

In the aircraft of FIG. 1, the eductor 150 can be provided in different forms. FIGS. 2-12B depict three different eductor embodiments. The first eductor embodiment, shown in FIGS. 2-5B, is identified by reference number 200. The second eductor embodiment, shown in FIGS. 6-9, is identified by reference number 300. The third eductor embodiment, shown in FIGS. 10-12B, is identified by reference number 400. In FIG. 1, the eductor 150 is identified by reference number 150. However, that eductor 150 can be in accordance with any of the three embodiments shown in FIGS. 2-12B. Moreover, while any of these three eductor embodiments can be used in an aircraft in the manner exemplified by FIG. 1, use of the eductor is not so limited. Rather, the eductor embodiments disclosed herein can be used in various other applications, such as mixing equipment in helicopters, emergency-response trucks or cars, portable firefighting equipment, etc.

FIGS. 2-5B illustrate a first embodiment of an eductor 200 configured to mix water together with a fire suppressant material, which can optionally be a powder (e.g., a firefighting solute). FIG. 2 is a perspective view of the eductor 200. The eductor 200 has a housing 202, which may comprise a plurality of bodies joined together integrally to form the eductor. The eductor 200 has inner 222 and outer 220 channels that are concentric and a manifold region 224 at a location where the inner and outer channels come together. The eductor 200 has a plurality of inlets (including at least one fire suppressant material inlet 206, a water inlet 204, and an air inlet 208) and an outlet 212. In the embodiment of FIG. 2, the plurality of inlets includes first and second fire suppressant material inlets 206, 210, a water inlet 204, and an air inlet 208. In other embodiments, the eductor has only a single fire suppressant material inlet.

As shown in FIG. 3A, the inner 222 and outer 220 channels preferably are concentric. For example, the outer channel 220 can be annular while the inner channel 222 is circular, e.g., such that the annular outer channel surrounds the circular inner channel. The illustrated inner 222 and outer 220 channels come together at the manifold region 224. The manifold region 224 is thus in communication with both the inner 222 and outer 220 channels, and is thereby configured to simultaneously receive material flow from both channels 220, 222. Preferably, the outer channel 220 includes an annular first region 226 and an annular funnel region 228. The annular funnel region 228 can serve as a transition between (and/or can extend between) the annular first region 226 and the manifold region 224. In some cases, the annular funnel region 228 becomes increasingly narrow in moving in a downstream direction, i.e., from the annular first region 226 toward the manifold region 224.

Eductor 200 preferably includes an outer tube 290 and an inner tube 270. The outer channel 220 can be located between (e.g., defined collectively by) the outer tube 290 and the inner tube 270. Accordingly, the outer channel 220 can have an annular configuration. The inner channel 222 can be located inwardly of (e.g., defined by) the inner tube 270. Thus, the inner tube 270 can bound the inner channel 222. The illustrated inner tube 270 has a proximal end and a distal end, with the distal end terminating at the manifold region 224.

The water inlet 204 is in fluid communication with a water supply (e.g., a water delivery line 152). Preferably, the water supply is equipped to provide pressurized water, e.g., such that the water supply is adapted to flow water rapidly through the eductor. The water supply, for example, can advantageously be coupled with a pump 154 configured to pump water into the water inlet 204. When eductor 200 is used on the aircraft 100 of FIG. 1, the water inlet 204 is in fluid communication with the water delivery line 152, which extends from the water tank 112. In such cases, the water inlet 204 of the eductor 200 is operably coupled with the pump 154, which is configured to pump water from the water tank 112 to the water inlet of the eductor via the water delivery line 152.

The air inlet 208 of eductor 200 is in fluid communication with an air supply. Preferably, the air supply comprises air moving at a high relative velocity, such that opening the air inlet 208 to the air supply causes air to flow rapidly through the eductor. When eductor 200 is used on the aircraft 100 of FIG. 1, the air inlet 208 of the eductor can be configured to receive air from outside the aircraft (e.g., via a ram intake). Thus, during flight, the relative speed of the aircraft and the surrounding air can cause air to flow rapidly into the air inlet 208, when opened, and through the eductor 200 (e.g., via an airflow passage extending through the fuselage). Alternatively, the air supply can simply be static air (e.g., within the fuselage) adjacent to the eductor's air inlet 208. In such cases, the above-noted vacuum created by water flowingly rapidly through the eductor can suck air into the eductor through the air inlet 208. Either way, the resulting air flow can provide an air purge of the eductor. More will be said of this later.

The first fire suppressant material inlet 206 is in communication with a first supply of fire suppressant material. When provided, the second fire suppressant material inlet 210 is in communication with a second supply of fire suppressant material. In the aircraft embodiment of FIG. 1, the first and second supplies of fire suppressant material are located respectively in the first and second floats 104 of the aircraft 100. In other embodiments, the eductor has two fire suppressant material delivery lines (e.g., coming respectively from two fire suppressant material supplies located respectively in the two floats) that merge into a single feed line attached to a single fire suppressant material inlet of the eductor. Still other embodiments provide three or more fire suppressant material delivery lines.

In connection with the aircraft embodiment of FIG. 1, the first fire suppressant material inlet 206 of eductor 200 may be in communication with a first hopper 128 via a first feed line 148. Similarly, the second fire suppressant material inlet 210 of eductor 200 can be in communication with a second hopper via a second feed line. In such cases, the first hopper 128 can be located within a first float 104, while the second hopper is located within a second float. In other embodiments, the eductor 200 may have only one of the first and second fire suppressant material inlets 208, 210. Or, both inlets 208, 210 may be provided, but only one is used.

In the eductor embodiment of FIG. 2, the water inlet 204 is located at one end (e.g., a bottom end) of the eductor 200 while the air inlet 208 and the fire suppressant material inlets 206, 210 are located at an opposite end (e.g., a top end). This type of configuration, however, is not required.

The outlet 212 of the eductor 200 is configured to deliver a combined stream of water and fire suppressant material out of the eductor. In embodiments where the eductor 200 is used on an aircraft 100 like that discussed above relative to FIG. 1, the eductor outlet 212 is configured to deliver a combined stream of water and fire suppressant material into the water tank 112. In FIGS. 2-5B, the outlet 212 of the eductor 200 is located at one side of the eductor (the “outlet side”) while the air inlet 208 and fire suppressant material inlets 206, 210 are located at an opposite side (the “inlet side”). It is to be appreciated, however, that this configuration is not required.

Eductor 200 has multiple configurations, including a mixing configuration, a rinse configuration, and an air purge configuration. When in the mixing configuration, eductor 200 is configured to mix together water and a fire suppressant material (and in some cases, to deliver the resulting mix into a water tank 112 of a firefighting aircraft 100). When in the rinse configuration, eductor 200 is configured to rinse out the inner channel 222 (e.g., so as to remove any fire suppressant material that may remain therein following the mixing cycle). When in the air purge configuration, eductor 200 is configured to blow out the inner channel 222 (e.g., so as to remove water that may be therein).

One method of operation includes the following sequence of steps: 1) operating eductor 200 while it is in the mixing configuration to mix together water and fire suppressant material (and in some case, delivering the resulting mixture out of the eductor into a water tank 112 of a firefighting aircraft), 2) moving the eductor from the mixing configuration to the rinse configuration, 3) operating the eductor while it is in the rinse configuration to rinse out the inner channel 222, 4) moving the eductor from the rinse configuration to the air purge configuration, and 5) operating the eductor while it is in the air purge configuration to blow water from the inner channel 222. This sequence of steps may be repeated each time the eductor is operated. Moreover, it is to be appreciated that this sequence may actually start with step 5, followed by steps 1, 2, 3, and 4. The sequence may subsequently be repeated, as desired, beginning with step 5.

The eductor 200 can optionally include a selector valve 230 to adjust the eductor between its different configurations. In the embodiment of FIGS. 2-5B, the selector valve 230 is a 5-way selector valve. In other cases (e.g., where the eductor has only one fire suppressant material inlet), it may be a 4-way selector valve. When provided, the selector valve 230 preferably has a valve member 232 to which a controller 234 is coupled. The controller can be, for example, a small DC gear motor, such as the model #VE5630 product that is manufactured by Rex Engineering Corporation of Titusville, Fla., U.S.A. and is sold commercially by Banjo Corporation of Crawfordsville, Ind., U.S.A. The controller 234, when actuated, causes the valve member 232 to move between various positions. The controller 234 can be powered by conventional means, such as electric or hydraulic power.

FIGS. 4A, 5A, and 5B each show eductor 200 in a mixing configuration. The cross-sectional view in FIG. 4A is taken along line A-A of FIG. 2. The cross-sectional view in each of FIGS. 5A and 5B is taken along line B-B of FIG. 2. When eductor 200 is in a mixing configuration, a primary water flow path extends from the water inlet 204, through the outer channel 220, and into the manifold region 224. Thus, the eductor 200, when in a mixing configuration, is configured to receive water (e.g., from a water tank 112) via water inlet 204. Such water then, in flowing along the primary water flow path, moves through the outer channel 220 and into the manifold region 224.

The mixing configuration of eductor 200 allows fire suppressant material (from a fire suppressant material inlet) to move through the inner channel 222 and into the manifold region 224, where it is mixed with water delivered to the manifold region through the outer channel 220. Thus, eductor 200 when in a mixing configuration has a first fire suppressant material flow path 248 extending from a first fire suppressant material inlet 206 or 210, through the inner channel 222, and into the manifold region 224. It can thus be appreciated that when eductor 200 is in the mixing configuration, water and fire suppressant material come together (e.g., are mixed together) at the manifold region 224.

The mixing configuration of eductor 200 can result, for example, from adjusting a selector valve 230, e.g., by moving a valve member 232 thereof. The embodiment of FIGS. 2-5B shows one such a selector valve 230. In FIG. 5A, the selector valve 230 is positioned such that the first fire suppressant material inlet 206 is open to the inner channel 222 of the eductor 200. In more detail, the valve member 232 provides an open passage for the delivery of fire suppressant material from the first fire suppressant material inlet 208 to the inner channel 222. At the same time, the valve member 232 blocks flow from the air inlet 208, the optional second fire suppressant material inlet 210, and bypass channel 242 to the inner channel 222.

Similarly, in FIG. 5B, the selector valve 230 is positioned such that the second fire suppressant material inlet 210 is open to the inner channel 222 of the eductor 200. Here, the valve member 232 provides an open passage for delivery of fire suppressant material from the second fire suppressant material inlet 210 to the inner channel 222. In more detail, the valve member 232 provides an open passage for the delivery of fire suppressant material from the second fire suppressant material inlet 210, through the inner channel 222, and into the manifold region 224. At the same time, the valve member 232 blocks flow from the air inlet 208, the first fire suppressant material inlet 206, and the bypass channel 242 to the inner channel 222. As noted above, although the illustrated eductor 200 has two fire suppressant material inlets 206, 210, in other embodiments the eductor has only one fire suppressant material inlet.

FIGS. 3A and 3B show the eductor 200 in the rinse configuration. FIG. 3A is a cross-sectional view of eductor 200 taken along line A-A of FIG. 2, while FIG. 3B is a cross-sectional view of eductor 200 taken along line B-B of FIG. 2. When in the rinse configuration, the eductor 200 has a secondary water flow path 238 extending from the water inlet 204, through the inner channel 222, and into the manifold region 224. In the illustrated embodiment, eductor 200 when in the rinse configuration simultaneously has a primary water flow path 236 extending from the water inlet 204, through the outer channel 220, and into the manifold region 224. As an alternative, water flow into the outer channel 220 may be selectively blocked during the rinse cycle.

In the illustrated embodiment of eductor 200, a primary water feed line 240 extends from the water inlet 204 to the outer channel 220. Thus, the primary water flow path 236 is defined by the water inlet 204, primary water feed line 240, outer channel 220, and manifold region 224. In addition, a bypass channel 242 is in communication with both the water inlet 204 (at a first end of the bypass channel) and the selector valve 230 (at a second end of the bypass channel). In the illustrated embodiment, the bypass channel 242 branches off from the primary water feed line 240 and extends to the selector valve 230. Thus, in some embodiments, a secondary water flow path 238 is defined by the water inlet 204, bypass channel 242, inner channel 222, and manifold region 224.

In FIGS. 2-5B, the rinse configuration of eductor 200 is established, at least in part, by the configuration of the selector valve 230, and more particularly by the position of its valve member 232. In FIGS. 3A and 3B, the valve member 232 of the selector valve 230 is positioned so as to be open to the bypass channel 242, such that the inner channel 222 is configured to accept water flow from the bypass channel. At the same time, the valve member 232 closes the inner channel 222 off from the air inlet 208 and the fire suppressant material inlet(s). This is shown in FIG. 3B. When in this configuration, the eductor 200 can receive water from the water inlet 204. From the water inlet 204, some of the received water travels along the primary water flow path 236, i.e., through the primary water feed line 240, through the outer channel 220, and into the manifold region 224. At the same time, the rest of the received water travels along the secondary water flow path 238, i.e., through the bypass channel 242, through the inner channel 222, and into the manifold region 224. Thus, water is allowed to pass through both the inner 222 and outer 220 channels during the rinse cycle, while air and fire suppressant material are simultaneously prevented from entering the inner channel from inlets 206, 208, and 210 due to the position of the valve member 232. It can thus be appreciated that the selector valve 230 is adjustable (e.g., via controller 234) to change the configuration of the eductor 200.

FIG. 4B is a cross-sectional view of eductor 200 in an air purge configuration. FIG. 4B is a cross-sectional view of the eductor 200 taken along line B-B of FIG. 2. The eductor 200 when in the air purge configuration has an air flow path extending from the air inlet 208, through the inner channel 222, and into the manifold region 224. In the illustrated embodiment, the air purge configuration differs from the rinse configuration in that the selector valve 230 has been actuated so as to move the valve member 232 to a position where it closes the inner channel 222 off from the bypass channel 242 and opens the inner channel 222 to the air inlet 208. In addition, the inner channel 222 is closed off from the fire suppressant material inlet(s). As a result, flow into the inner channel 222 from the bypass channel 242, as well as flow from the fire suppressant material inlet(s), is prevented.

In the air purge configuration shown in FIG. 4B, the primary water flow path 236 extends from the water inlet 204, through the outer channel 220, and into the manifold region 224. Simultaneously, the air flow path 244 extends from the air inlet 208, through the inner channel 222, and into the manifold region 224. During operation of the eductor 200 in the air purge configuration, air received at the air inlet 208 (from the air supply) flows rapidly along the air flow path 244 through the inner channel 222 and into the manifold region 224. At this time, water may be simultaneously delivered along the primary water flow path 236. Alternatively, when the eductor 200 is in the air purge configuration, the pump used to convey water from the water tank along the water delivery line may be shut off, such that water no longer flows into the water inlet 204.

In the embodiment of FIGS. 2-5B, each fire suppressant material inlet 206, 210 is closed when the eductor 200 is in either the rinse configuration or the air purge configuration.

During operation of a firefighting aircraft 100, the eductor can be switched selectively between the mixing, rinse, and air purge configurations. For example, when desired, the eductor can be operated in the mixing configuration, which may involve the selector valve being positioned so as to open the first fire suppressant material inlet to the inner channel. In this configuration, water is received at the water inlet from the water supply (e.g., from water tank 112). This involves operating the pump 154 to convey water from the water tank 112 to the water inlet 204. The received water travels along the primary water flow path, i.e., through the outer channel 220 and into the manifold region 224. As noted above, the flow of water through the outer channel 220 can be used as a motive fluid to create a vacuum that draws fire suppressant material (in some cases, powder from a powder hopper) into the eductor through the first fire suppressant material inlet 206, along the inner channel 222, and to the manifold region 224. At the manifold region 224, the fire suppressant material and water come together and thus can be mixed. The resulting mixture of fire suppressant material and water can then be delivered out of the eductor into the water tank 112 via the eductor outlet 212.

Throughout a fire-fighting campaign, it will typically be desirable to keep the weight of the first float as close as possible to the weight of the second float. Thus, if the present system is initially operated using fire suppressant material from a supply in the first float (thereby using the first fire suppressant material inlet 206), once the resulting tank-load is dropped, it will typically be desirable to switch to using the other fire suppressant material supply (which is in the second float), thereby using the second fire suppressant material inlet 210, for mixing the next tank-load. To keep the aircraft 100 well balanced, it is desirable to continue alternating in this manner from mixing one tank-load to mixing the next.

When the aircraft 100 is flying over a desired target (e.g., a fire, a particular area of a fire, or a structure to be saved), the door 118 of the water tank 112 is opened and the mixture of water and fire suppressant material in the tank is thereby dropped onto the desired target. At this point, the water tank 112 will be empty, so the pump 154 previously used to deliver water from the water tank to the water inlet 204 of the eductor should be deactivated (if it has not already been shut off). Furthermore, after performing the mixing operation for some time, the water tank 112 may come to an appropriately mixed state, at which time the supply of water to the eductor may be stopped. When water is not flowing rapidly through the eductor, fire suppressant material will not be drawn through the fire suppressant material inlet into the inner channel 222. However, at the moment water stops flowing through the eductor, some residual fire suppressant material (drawn previously into the inner channel 222) may remain in the inner channel and/or manifold region 224. Without further action, depending on the construction of the eductor, as well as the form, consistency, and composition of the fire suppressant material, such residual material may clog internal portions of the eductor or otherwise impede optimal performance.

To avoid such problems, the eductor 200 can be switched to the rinse configuration. In the rinse configuration, the selector valve can be positioned so as to open the secondary water flow path, which extends through the inner channel and to the manifold region. Thus, water can simultaneously be delivered to the manifold region via the primary and secondary water flow paths (e.g., such that the eductor is configured to receive water flow through both the inner 222 and outer 220 channels). The rinse configuration can therefore be used advantageously (e.g., after a mixing cycle) to clean out the inner channel 222 of the eductor. For example, if the fire suppressant material is in powder form, then operating the eductor 200 in the rinse configuration can effectively flush out any wet powder that may be left inside the inner channel 222 after the mixing operation has ended.

Once a rinse cycle has cleaned out the inner channel 222 (or otherwise prior to beginning a mixing cycle), the eductor can be switched to the air purge configuration. In the air purge configuration, the selector valve 232 can be positioned so as to open the inner channel to the air inlet 208. A rapid flow of air through the inner channel 222 can act to dry out this internal area of the eductor, which may have some water left in it from the previous rinse cycle. Drying out the inner channel can help to prevent powder or the like from sticking to what may otherwise be a damp interior of the inner channel 222 during a subsequent mixing configuration. For example, if significant amounts of water are in the inner channel 222 when a mixing cycle is initiated, then powder flowing through the inner channel may become sticky upon contact with the water. This may clog the eductor or otherwise impede its efficient operation (e.g., preventing optimal mixing of powder with water).

As already explained, the fire suppressant material need not always be a powder. However, the eductor 200 has the distinct advantage of being capable of use with a powder fire suppressant material.

Thus, the multiple configurations (and corresponding cycles) of eductor 200 can allow a firefighting aircraft 100 to sustain continuous firefighting operations for extended periods of time without needing to stop at a land base to refill the water tank or mix fire suppressant material with water therein. The aircraft 100 can repeatedly drop and reload the water tank 112, mix fire suppressant material with the water (e.g., during flight), and keep the eductor operating properly to reduce interruptions in the firefighting operation.

In the foregoing description, intakes 206 and 210 were used as fire suppressant material inlets, while intake 208 was used as the air inlet. The eductor 200 can alternatively be configured such that intakes 208 and 206 are used as fire suppressant material inlets, while intake 210 is used as the air inlet.

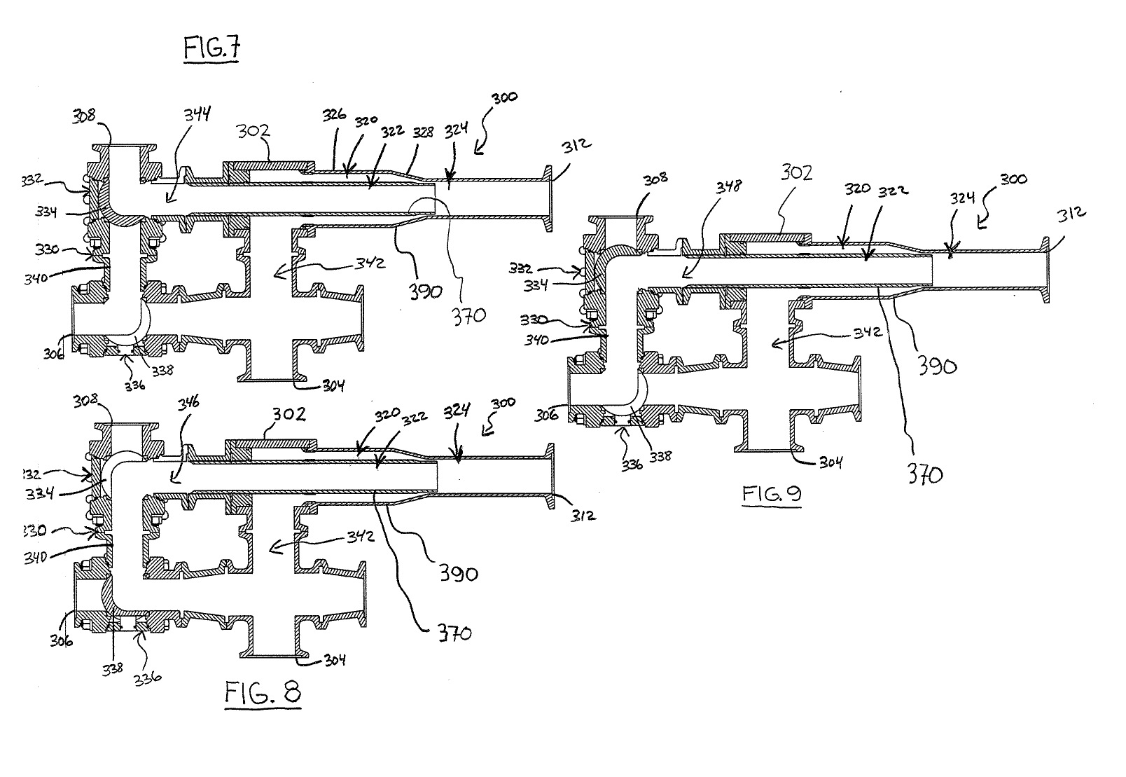

FIGS. 6-9 illustrate an eductor 300 in accordance with a second embodiment of the invention. In particular, FIG. 6 shows a perspective view of eductor 300, while FIGS. 7-9 show cross-sectional views of eductor 300 in various configurations taken along line C-C of FIG. 6.

Eductor 300 has a housing 302, which may comprise a plurality of bodies joined together integrally to form the eductor. The eductor 300 has inner 322 and outer 320 channels that are concentric and a manifold region 324 at a location where the inner and outer channels come together. The eductor 300 has a plurality of inlets (including at least one fire suppressant material inlet 308, a water inlet 304, and an air inlet 306) and an outlet 312. In the embodiment of FIG. 6, the plurality of inlets includes only one fire suppressant material inlet 308. In other embodiments, the eductor includes two fire suppressant material inlets.

As shown in FIGS. 7-9, the inner 322 and outer 320 channels preferably are concentric. For example, the outer channel 320 can be annular while the inner channel 322 is circular, e.g., such that the annular outer channel surrounds the circular inner channel. The illustrated inner 322 and outer 320 channels come together at the manifold region 324. The manifold region 324 is thus in communication with both the inner 322 and outer 320 channels, and is thereby configured to simultaneously receive material flow from both channels 320, 322. Preferably, the outer channel 320 includes an annular first region 326 and an annular funnel region 328. The annular funnel region 328 can serve as a transition between (and/or can extend between) the annular first region 326 and the manifold region 324. In some cases, the annular funnel region 328 becomes increasingly narrow in moving in a downstream direction, i.e., from the annular first region 326 toward the manifold region 324.

Eductor 300 preferably includes an outer tube 390 and an inner tube 370. The outer channel 320 can be located between (e.g., defined collectively by) the outer tube 390 and the inner tube 370. Accordingly, the outer channel 320 can have an annular configuration. The inner channel 322 can be located inwardly of (e.g., defined by) the inner tube 370. Accordingly, the inner tube 370 can bound the inner channel 322. The illustrated inner tube 370 has a proximal end and a distal end, with the distal end terminating at the manifold region 324.

The water inlet 304 is in fluid communication with a water supply (e.g., a water delivery line). Preferably, the water supply provides pressurized water, e.g., such that the water supply is adapted to flow water rapidly through the eductor. The water supply, for example, can advantageously be coupled with a pump 154 configured to pump water into the water inlet 304. When eductor 300 is used on the aircraft 100 of FIG. 1, the water inlet 304 is in fluid communication with the water delivery line 152, which delivers water from (e.g., extends from) the water tank 112 to the eductor 300. In such cases, the water inlet 304 of the eductor is operably coupled with the pump 154, which is configured to pump water from the water tank 112 to the water inlet of the eductor via the water delivery line 152.

The fire suppressant material inlet 308 of eductor 300 is in communication with a supply of fire suppressant material. In the aircraft embodiment of FIG. 1, a supply of fire suppressant material is located respectively in the first float 104 of the aircraft 100. In other embodiments, the eductor has two fire suppressant material inlets, which are respectively in communication with two supplies of fire suppressant material located respectively in the first and second floats. Still other embodiments provide three or more fire suppressant material inlets. Another possibility is to have two fire suppressant material delivery lines (e.g., coming respectively from two fire suppressant material supplies located respectively in the two floats) that merge into a single feed line attached to the fire suppressant material inlet 308.

In connection with the aircraft embodiment of FIG. 1, the fire suppressant material inlet 308 of eductor 300 may be in communication with a first hopper 128 via a first feed line 148.

In the embodiment of FIGS. 6-9, the water inlet 304 is located at one end (e.g., a bottom end) of the eductor 300 while the fire suppressant material inlet 308 is located at an opposite end (e.g., a top end). This configuration, however, is not required.

The air inlet 306 of eductor 300 is in fluid communication with an air supply. Preferably, the air supply comprises air moving at a high relative velocity, such that opening the air inlet 306 to the air supply causes air to flow rapidly through the eductor. When eductor 300 is used on the aircraft 100 of FIG. 1, the air inlet 306 of the eductor can be configured to receive air from outside the aircraft (e.g., via a ram intake). Thus, during flight, the relative speed of the aircraft and the surrounding air can cause air to flow rapidly into the air inlet 306, when opened, and through the eductor 300 (e.g., via an airflow passage extending through the fuselage). Alternatively, the air supply can simply be static air (e.g., within the fuselage) adjacent to the eductor's air inlet 306. In such cases, the above-noted vacuum created by water flowingly rapidly through the eductor can suck air into the eductor through the air inlet 306. Either way, the resulting air flow can provide an air purge of the eductor.

The outlet 312 of the eductor 300 is configured to deliver a combined stream of water and fire suppressant material out of the eductor. In embodiments where the eductor 300 is used on an aircraft 100 like that discussed above relative to FIG. 1, the eductor outlet 312 is configured to deliver a combined stream of water and fire suppressant material into the water tank 112. In FIGS. 6-9, the outlet 312 of the eductor 300 is located at one side of the eductor (the “outlet side”) while the air inlet 306 and the fire suppressant material inlet 308 are located at an opposite side (the “inlet side”). It is to be appreciated, however, that this configuration is not required.

Eductor 300 has multiple configurations, including a mixing configuration, a rinse configuration, and an air purge configuration. When in the mixing configuration, eductor 300 is configured to mix together water and a fire suppressant material (and in some cases, to deliver the resulting mix into a water tank 112 of a firefighting aircraft 100). When in the rinse configuration, eductor 300 is configured to rinse out the inner channel 322 (e.g., so as to remove any fire suppressant material that may remain therein following a mixing cycle). When in the air purge configuration, eductor 300 is configured to blow out the inner channel 322 (e.g., so as to remove water that may be therein).

One method of operation involves the following sequence of steps: 1) operating eductor 300 while it is in the mixing configuration to mix together water and fire suppressant material (and in some case, delivering the resulting mixture to a water tank 112 of a firefighting aircraft), 2) moving the eductor from the mixing configuration to the rinse configuration, 3) operating the eductor while it is in the rinse configuration to rinse out the inner channel 322, 4) moving the eductor from the rinse configuration to the air purge configuration, and 5) operating the eductor while it is in the air purge configuration to blow water from the inner channel 322. This sequence of steps may be repeated each time the eductor is operated. Moreover, it is to be appreciated that the sequence may actually start with step 5, followed by steps 1, 2, 3, and 4. The sequence may subsequently be repeated, as desired, beginning with step 5.

Eductor 300 includes a valve system 330, which is operable to adjust the eductor between its different configurations. The valve system 330, in some examples, includes a first three-way valve 332 having a first valve member 334 that is movable between first and second positions. The valve system 330 can further include a second three-way valve 336 having a second valve member 338 that is movable between first and second positions. Thus, the eductor 300 embodiment of FIGS. 6-9 includes two three-way valves 332, 336. In this embodiment, a bypass channel 340 extends between the first and second three-way valves 332, 336. This enables fluid communication between the first and second three-way valves 332, 336. One or more controllers can be coupled to the first and second three-way valves 332, 336. The controller(s) is/are operable actuate the first and second three-way valves, i.e., to move the respective first and second valve members 334, 338 between their first and second positions. In some cases, each of the three-way valves 332, 336 is coupled to a controller in the form of a small DC gear motor, such as the EV4100 product that is commercially available from Banjo Corporation of Crawfordsville, Ind., U.S.A. The controller(s) can be powered by any means, e.g., electric or hydraulic power.

The eductor 300 shown in FIG. 7 is in the mixing configuration. When in the mixing configuration, the eductor 300 has a primary water flow path 342 extending from the water inlet 304, through the outer channel 320, and into the manifold region 324. At the same time, when in the mixing configuration, the eductor 300 has a fire suppressant material flow path 344 extending from the fire suppressant material inlet 308, through the inner channel 322, and into the manifold region 324. The fire suppressant flow path 344, when the illustrated eductor 300 is in the mixing configuration, is facilitated by the position of the first valve member 334. Specifically, this valve member 334 is in a first position, in which it provides an open passage for flow from the fire suppressant material inlet 308 into the inner channel 322, and simultaneously blocks flow from the bypass channel 340 into the inner channel 322 (so as to prevent flow into the inner channel from the air inlet 306 or from the water inlet 308).

When in the mixing configuration, eductor 300 operates in manner similar to that described previously with respect to the mixing configuration of eductor 200. For example, water is received at the water inlet 304, preferably due to a pump that pumps water from a water supply (e.g., a water tank 112) to the water inlet. The received water can travel along the primary water flow path 342, which involves such water moving through the outer channel 320 and into the manifold region 324. The flow of water through the outer channel 320 can be used as a motive fluid to create a vacuum to draw fire suppressant material (in some cases, powder from a powder hopper) through the fire suppressant material inlet 308, into the inner channel 322, and to the manifold region 324. At the manifold region 324, the fire suppressant material and water converge and can thus be mixed together. The resulting mixture of fire suppressant material and water can then be delivered out of the eductor's outlet 312 (and in some cases, into a water tank).

Thus, in the embodiment shown in FIGS. 6-9, the configuration of the eductor 300 can be changed by actuating the first and/or second three-way valves 332, 336.

FIG. 8 shows eductor 300 in a rinse configuration. When in the rinse configuration, eductor 300 has a secondary water flow path 346 extending from the water inlet 304, through the inner channel 322, and into the manifold region 324. At the same time, eductor 300 when in the rinse configuration can optionally also have open the primary water flow path 342, which extends from the water inlet 304, through the outer channel 320, and into the manifold region 324. In the embodiment of FIG. 8, the secondary water flow path 346 is established by the positions of the first and second three-way valves 332, 336. In particular, the first valve member 334 is in a second position (which is different from the noted first position), in which it simultaneously blocks flow from the fire suppressant material inlet 308 to the inner channel 322 and provides an open passage for flow from the bypass channel 340 into the inner channel. To allow water flow through the bypass channel 340 (e.g., rather than allowing air flow there through), the second valve member 338 is in a position that simultaneously: i) provides an open passage for water flow from the water inlet 304 into the bypass channel 340, and ii) blocks air flow from the air inlet 306 into the bypass channel 340.

Eductor 300 when in the rinse configuration operates in a manner similar to that described previously with respect to the rinse configuration of eductor 200. For example, water is received into the eductor via the water inlet 304 (in some cases, from a water tank 112). Some of the received water travels along the primary water flow path 342, e.g., through the outer channel 320 and into the manifold region 324. In addition, some of the received water travels along the secondary water flow path 346, e.g., past three-way valve 336, through the bypass channel 340, past three-way valve 332, through the inner channel 322, and into the manifold region 324. In some cases, it is desirable to operate the eductor 300 in the rinse configuration after each mixing cycle, e.g., so as to clean out the inner channel 322 (e.g., to remove any residual fire suppressant material that may have been left in the inner channel after a previous mixing operation).

Thus, in the embodiment of FIGS. 6-9, to adjust the eductor 300 from the mixing configuration to the rinse configuration, at least one of the three-way valves 332, 336 is moved to a different position. In preferred embodiments, both of the three-way valves 332, 336 are moved to different positions in adjusting the eductor 300 from the mixing configuration to the rinse configuration.

FIG. 9 shows eductor 300 in an air purge configuration. In this configuration, the eductor 300 has an air flow path 348 extending from the air inlet 306, through the inner channel 322, and into the manifold region 324. When eductor 300 is in the air purge configuration, it can optionally have open the primary water flow path 342, which extends from the water inlet 304, through the outer channel 320, and into the manifold region 324. During an air purge operation, water may or may not be flowing along the primary water flow path 342. In the illustrated embodiment, the air flow path 348 is established by the positions of the first and second three-way valves 332, 336. In particular, the first valve member 334 is in a second position (which is the same position used when eductor 300 is in the rinse configuration), in which it simultaneously: i) blocks flow from the fire suppressant material inlet 308 to the inner channel 322, and ii) provides an open passage for air flow from the bypass channel 340 into the inner channel. To facilitate air flow through the bypass channel 340 (as opposed to water flow there through), the second valve member 338 is in a position that simultaneously: 1) creates an open passage for air flow from the air inlet 306 into the bypass channel 340, and 2) blocks water flow from the water inlet 304 into the bypass channel 340.

Thus, eductor 300 when in the air purge configuration operates in a manner similar to that described previously with respect to the air purge configuration of eductor 200. For example, air received at the air inlet 306 (e.g., from an air source) travels along an air flow path 348, through the inner channel 322, and into the manifold region 324. In the embodiment shown by FIG. 9, the air flow path 348 extends past three-way valve 336, along the bypass channel 340, past three-way valve 332, through the inner channel 322, and into the manifold region 324. At the same time, water can optionally be pumped to the water inlet 304 (e.g., from a water tank 112) so as to travel along the primary water flow path 342, e.g., through the outer channel 320 and into the manifold region 324. It may be desirable to operate the eductor 300 in the air purge configuration after each rinse cycle in order to dry out the inner channel 322 of the eductor 300, which may be damp at the conclusion of a previous rinse cycle. More generally, it may be desirable to operate the eductor 300 in the air purge configuration before initiating any mixing cycle. Drying out the inner channel 322 of the eductor 300 before initiating a mixing cycle, can help prevent fire suppressant material from accumulating within the inner channel 322. For example, if the inner channel 322 were still wet inside upon starting a mixing cycle, and if powder were used as the fire suppressant material, then the powder may get sticky and cause clogging or otherwise adversely affect the performance of the eductor.

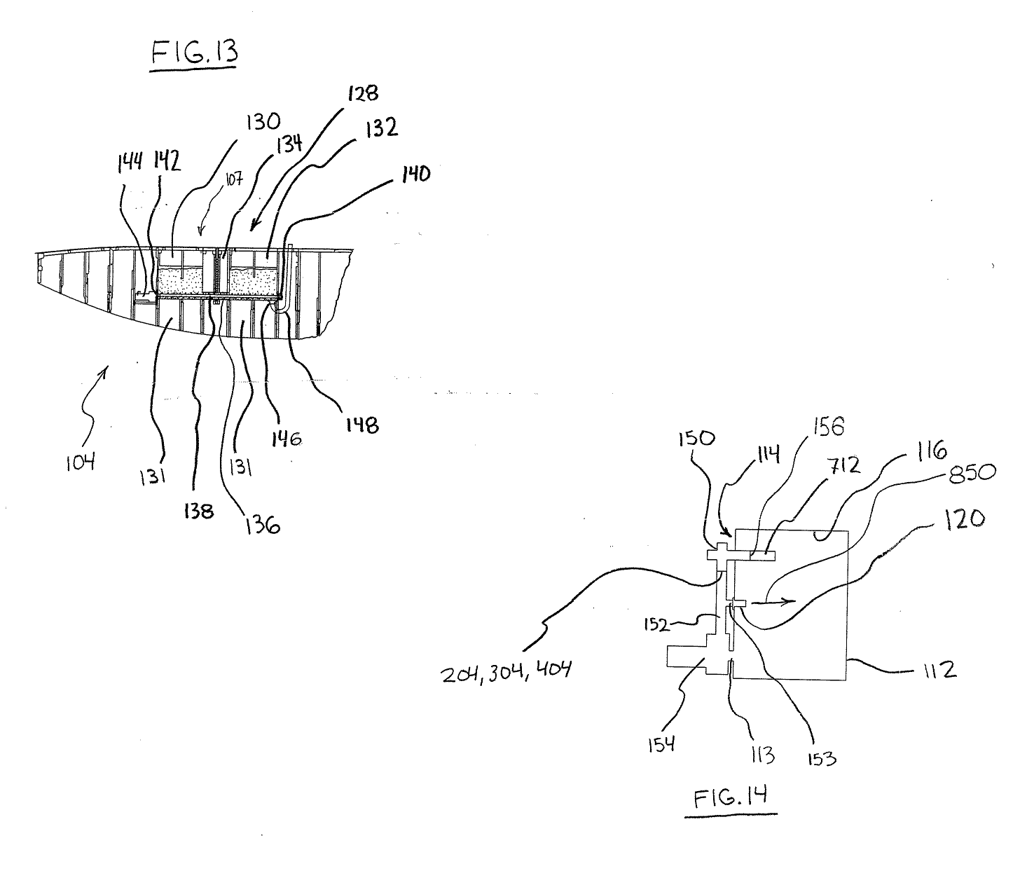

FIGS. 10-12B illustrate an eductor 400 in accordance with a third embodiment of the invention. In particular, FIG. 10 shows a side view of eductor 400. FIGS. 11 and 12A show cross-sectional views of the eductor 400 of FIG. 10, and FIG. 12B shows a broken-away close-up perspective view of a blocker head of a shut-off plunger of eductor 400.

Eductor 400 has a housing 402, which may comprise a plurality of bodies joined together integrally to form the eductor. The eductor 400 has inner 422 and outer 420 channels that are concentric and a manifold region 424 at a location where the inner and outer channels come together. The eductor 400 has a plurality of inlets (including at least one fire suppressant material inlet 408, a water inlet 404, and an air inlet 406) and an outlet 412. In the embodiment of FIGS. 10-12B, the plurality of inlets includes only one fire suppressant material inlet 408. In other embodiments, the eductor includes two fire suppressant material inlets.

FIGS. 10-12B depict an embodiment wherein the housing 403 of the eductor 400 is elongated along a longitudinal axis (referring to FIGS. 11 and 12A, the longitudinal axis is coaxial with the shaft 448 of the shut-off plunger 438). In FIGS. 11 and 12A, it can be seen that the water inlet 404 intersects the housing at an angle orthogonal to the longitudinal axis. In the illustrated embodiment, the eductor 400 has an input line 480 through which fire suppressant material can be delivered to the inner channel 422. The illustrated input line 480 extends along an axis that is offset from the longitudinal axis by a desired acute angle, such that the input line intersects the inner channel 422 at the desired acute angle. It is to be appreciated, however, that this arrangement is not required.

In the present embodiment, the inner 422 and outer 420 channels preferably are concentric. For example, the outer channel 420 can be annular while the inner channel 422 is circular, e.g., such that the annular outer channel surrounds the circular inner channel. The illustrated inner 422 and outer 420 channels come together at the manifold region 424. The manifold region 424 is thus in communication with both the inner 422 and outer 420 channels, and is thereby configured to simultaneously receive material flow from both channels. Preferably, the outer channel 420 includes an annular first region 426 and an annular funnel region 428. The annular funnel region 428 can serve as a transition between (and/or can extend between) the annular first region 426 and the manifold region 424. In some cases, the annular funnel region 428 becomes increasingly narrow in moving in a downstream direction, i.e., from the annular first region 426 toward the manifold region 424.

Eductor 400 preferably includes an outer tube 430 and an inner tube 432. The outer channel 420 can be located between (e.g., defined collectively by) the outer tube 430 and the inner tube 432. Accordingly, the outer channel 420 can have an annular configuration. The inner channel 422 can be located inwardly of (e.g., defined by) the inner tube 432. Accordingly, the inner tube 432 can bound the inner channel 422. The illustrated inner tube 432 has a proximal end 434 and a distal end 436, with the distal end 436 terminating at the manifold region 424.

The fire suppressant material inlet 408 of eductor 400 is in communication with a supply of fire suppressant material. In the aircraft embodiment of FIG. 1, a supply of fire suppressant material is located respectively in the first float 104 of the aircraft 100. In other embodiments, the eductor has two fire suppressant material inlets, which are respectively in communication with two supplies of fire suppressant material located respectively in the first and second floats. Still other embodiments provide three or more fire suppressant material inlets. Another possibility is to have two fire suppressant material delivery lines (e.g., leading respectively from two fire suppressant material supplies located respectively in the two floats) that merge into a single feed line attached to the fire suppressant material inlet 408.

In connection with the aircraft embodiment of FIG. 1, the fire suppressant material inlet 408 of eductor 400 may be in communication with a first hopper 128 via a first feed line 148.

The water inlet 404 is in fluid communication with a water supply (e.g., a water delivery line). Preferably, the water supply provides pressurized water, e.g., such that the water supply is adapted to flow water rapidly through the eductor. The water supply, for example, can advantageously be coupled with a pump 154 configured to pump water into the water inlet 404. When eductor 400 is used on the aircraft 100 of FIG. 1, the water inlet 404 is in fluid communication with the water delivery line 152, which delivers water from (e.g., extends from) the water tank 112. In such cases, the water inlet 404 of the eductor is operably coupled with the pump 154, which is configured to pump water from the water tank 112 to the water inlet of the eductor via the water delivery line 152.

The air inlet 406 of eductor 400 is in fluid communication with an air supply. Preferably, the air supply comprises air moving at a high relative velocity, such that opening the air inlet 406 to the air supply causes air to flow rapidly through the eductor. When eductor 400 is used on the aircraft 100 of FIG. 1, the air inlet 406 of the eductor can be configured to receive air from outside the aircraft (e.g., via a ram intake). Thus, during flight, the relative speed of the aircraft and the surrounding air can cause air to flow rapidly into the air inlet 406, when opened, and through the eductor (e.g., via an airflow passage extending through the fuselage). Alternatively, the air supply can simply be static air (e.g., within the fuselage) adjacent to the eductor's air inlet 406. In such cases, the above-noted vacuum created by water flowing rapidly through the eductor can suck air into the eductor through the air inlet 306. Either way, the resulting air flow can provide an air purge of the eductor.

The outlet 412 of eductor 400 is configured to deliver a combined stream of water and fire suppressant material out of the eductor. In embodiments where eductor 400 is used on an aircraft 100 like that discussed above relative to FIG. 1, the eductor outlet 412 is configured to deliver a combined stream of water and fire suppressant material into the water tank 112. In FIGS. 10-12B, the outlet 412 of eductor 400 is located at one side of the eductor (the “outlet side”) while the air inlet 406 and the fire suppressant material inlet 408 are located adjacent to an opposite side (the “inlet side”). It is to be appreciated, however, that this configuration is not required.

As noted above with respect to the aircraft embodiment of FIG. 1, the eductor can be mounted below the maximum water line of the water tank 112. Thus, the outlet of the eductor can in some cases be in fluid communication with the top end region 114 of the water tank 112, which can result in water from the water tank having an open passage to inadvertently pass from the water tank into the eductor outlet.

In the embodiment of FIGS. 10-12B, the eductor 400 has a shut-off plunger 438. The shut-off plunger 438 has a leading end region 440 and a trailing end region 442. The leading end region 440 has a blocker head 444. The trailing end region 442 may include a stop block 446. A shaft 448 of the shut-off plunger 438 extends between the leading and trailing end regions 440, 442. This shaft 448 can have a width (e.g., diameter) less than that of the blocker head 444, the stop block 446, or both.

In the illustrated embodiment, the blocker head 444 comprises a generally cylindrical body. This generally cylindrical body can advantageously have a diameter that substantially matches the interior diameter of the inner tube 432. If desired, the blocker head can comprise a disk or puck shaped body. The blocker head 444 can, for example, comprise a nylon or resin material, optionally having an O-ring (e.g., formed of rubber) defining a cylindrical sealing surface, which engages the inside surface of the inner tube 432. The cylindrical sealing surface of the illustrated blocker head 444 is configured to slide along the inside surface of the inner tube 432 when the shut-off plunger 438 is moved within the inner channel 422. Thus, when the shut-off plunger 438 is moved axially (e.g., within the inner channel 422) from a retracted position to an extended position, its blocker head 444 can advantageously slide along the inside of the inner tube 432. In so doing, the blocker head 444 can advantageously scrape clean fire suppressant material residue that may be stuck to the inside surface of the inner tube.

The shut-off plunger 438 is mounted for axial movement within the inner channel 422 (e.g., inside the inner tube 432). The shut-off plunger 438, for example, can be incorporated into the eductor 400 so as to be moveable axially between a retracted position and an extended position. FIG. 11 shows the shut-off plunger 438 in the retracted position. In this position, the shut-off plunger 438 does not block the inner channel 422, but rather leaves it open to receive fire suppressant material from the fire suppressant material inlet 408 (or air from the air inlet 406, depending upon whether the eductor is in the mixing configuration or the air purge configuration). In the illustrated embodiment, the shut-off plunger 438, when in the retracted position, has its blocker head 444 positioned adjacent to the proximal end 434 of the inner tube 432, while the optional stop block 446 is spaced from the proximal end 434 by a distance set by the length of the shaft 448. Thus, when the illustrated shut-off plunger 438 is in the retracted position, the inner channel 422 of eductor 400 is open for conveying material there through (i.e., fire suppressant material from the fire suppressant material inlet 408 or air from the air inlet 406).

FIGS. 12A and 12B show the shut-off plunger 438 in the extended position. In this position, the shut-off plunger 438 provides a barrier to water that may otherwise move from the manifold region 424 into the inner channel 422. In more detail, when the shut-off plunger 438 is in the extended position, its blocker head 444 is positioned within the inner tube 432 at a location adjacent to the distal end 436. FIG. 12B is a close-up view of the shut-off plunger 438 when in the extended position of FIG. 12A. Here, it can be appreciated that the blocker head 444 provides a barrier to water moving from the manifold region 424 into the inner tube 432. The blocker head 444 of the shut-off plunger 438 preferably is sized to block substantially an entire diameter of the inner tube 432. In such cases, the blocker head 444 can substantially or entirely prevent water from entering the inner channel 422 from the manifold region 424.

An eductor having such a shut-off plunger can be advantageous, for example, when the eductor will be mounted below the maximum water line 116 of a water tank 112. In such cases, water may otherwise inadvertently pass from the water tank into the inner channel of the eductor. When the eductor has a shut-off plunger, however, it can be moved to the extended position, thereby preventing such water from entering the inner channel 422/inner tube 432 of the eductor 400.

In the embodiment shown in FIGS. 10-12B, during movement of the shut-off plunger 438 to its extended position (movement to the right, as seen in FIGS. 11 and 12A), the shaft 448 of the shut-off plunger 438 can slide through (and relative to) an interference block 450. The optional interference block 450 is shown mounted in a fixed position adjacent to the proximal end 434 of the inner tube 432. When provided, the interference block 450 can provide a limit stop for the optional stop block 446 on the trailing end region 442 of the plunger 438 so as to terminate forward movement of the plunger 438 when the blocker head 444 reaches it desired position at or adjacent to the distal end region of the inner tube 432.

The shut-off plunger 438 can comprise, for example, a plunger head on the leading end of a hydraulic ram. The hydraulic ram can be coupled with a hydraulic cylinder 470. In such cases, the hydraulic cylinder 470 preferably is configured to move the hydraulic ram axially between retracted and extended positions. In one non-limiting example, the hydraulic cylinder 470 is the HV series hydraulic cylinder sold commercially under the trade name tom Thumb™ by PHD Inc. of Fort Wayne, Ind., U.S.A. The hydraulic ram preferably has a length sized to provide for a thorough sweep of the inner tube 432 in moving from the retracted position to the extended position.

In the embodiment of FIGS. 10-12B, the eductor 400 includes a valve system 452. The illustrated valve system 452 comprises a three-way valve 454 having a valve member 456 that is moveable between different positions. In this particular embodiment, the valve system 452 has only a single three-way valve 454. Eductor 400 has different configurations, which correspond to respective positions of the valve member 456.

In FIG. 11, the eductor 400 is shown in a mixing configuration. In this configuration, the eductor 400 has a primary water flow path 458 extending from the water inlet 404, through the outer channel 420, and into the manifold region 424. At the same time, the eductor 400 when in the mixing configuration has a fire suppressant material flow path 460 extending from the fire suppressant material inlet 408, through the inner channel 422, and into the manifold region 424. In the illustrated embodiment, when eductor 400 is in the mixing configuration, the valve member 456 is in a first position, in which the valve member provides an open passage for flow from the fire suppressant material inlet 408 to the inner channel 422. At the same time, when the valve member 456 is in this position, it blocks flow from the air inlet 406 to the inner channel 422. Thus, when the eductor 400 is in the mixing configuration, the inner channel 422 is closed off from the air inlet 406 by the three-way valve 454. Moreover, when eductor 400 is in the mixing configuration, the shut-off plunger 438 is in the retracted position, such that the inner channel 422 is open to receive a flow of fire suppressant material (from the fire suppressant material inlet 408) along the fire suppressant material path 460, which passes through the inner channel 422 and out from the eductor outlet 412.

When in the mixing configuration, eductor 400 operates in a manner similar to that described previously with respect to the mixing configurations of eductor 200 and eductor 300. For example, water is received at the water inlet 404, preferably due to a pump that moves water from a water supply (e.g., a water tank 112) to the water inlet 404. The received water can travel along the primary water flow path 458, which involves such water moving through the outer channel 420 and into the manifold region 424. The flow of water through the outer channel 420 can be used as a motive fluid to create a vacuum that draws fire suppressant material (in some cases, powder from a powder hopper) through the fire suppressant material inlet 408, into the inner channel 422, and to the manifold region 424. At the manifold region 424, the fire suppressant material and water converge and thus can be mixed together. The resulting mixture of fire suppressant material and water can then be delivered out of the eductor's outlet 412 (and in some cases, into a water tank 112).

In the embodiment shown in FIGS. 10-12B, the configuration of the eductor 400 can be changed by actuating the three-way valve 454. However, it is not necessary that eductor 400 have the illustrated type of valve system. Rather, eductor 400 can be provided in a variety of different forms. More generally, the present embodiment extends to any eductor that includes a shut-off plunger of the nature described above.

In FIGS. 10-12B, the illustrated three-way valve 454 is operable (i.e., can be actuated) to change the position of the valve member 456. Doing so changes the configuration of the eductor 400. The valve system (e.g., a control arm thereof) 452 can be coupled to any suitable mechanical, electrical, and/or hydraulic controller for actuating the three-way valve 454. The controller is operable actuate the three-way valve, i.e., to move it between first and second positions. In some cases, the three-way valve is coupled to a controller in the form of a small DC gear motor, such as the EV4100 product that is commercially available from Banjo Corporation of Crawfordsville, Ind., U.S.A. The controller(s) can be powered by any means, e.g., electric or hydraulic power.

When eductor 400 is in the air purge configuration, the eductor has an air flow path 462 extending from the air inlet 406, through the inner channel 422, and into the manifold region 424. When eductor 400 is in the air purge configuration, the shut-off plunger 438 is in its retracted position, such that the inner channel 422 is open to receive a flow of air (from the air inlet 406) along the air flow path 462, which passes through the inner channel and out from the eductor outlet 412. At the same time, eductor 400 may have the primary water flow path 458, which extends from the water inlet 404, through the outer channel 420, and into the manifold region 424. It is to be understood that, during the air purge cycle, water may or may not be pumped through the eductor.

In the illustrated embodiment, when eductor 400 is in the air purge configuration, the valve member 456 is in a second position. In this position, the valve member 456 provides an open passage for air flow from the air inlet 406 to the inner channel 422. At the same time, the valve member closes the fire suppressant material inlet 408, such that flow from the fire suppressant material inlet to the inner channel 422 is prevented.

When operating eductor 400 in the air purge configuration, the eductor receives air flow from the air inlet 406, past the three-way valve 454, through the inner channel 422, and into the manifold region 424. Optionally, water can simultaneously be pumped through the eductor via the water inlet 404, so as to flow through the outer channel 420 and into the manifold region 424. From the manifold region 424, air, and if desired, water, can be expelled out of the eductor 400 from the outlet 412. As noted above, when eductor 400 is in the air purge configuration, the shut-off plunger 438 should be in the retracted position, such that the inner channel 422 is fully open to receive air flow from the air inlet 406.

When the eductor 400 is maintained in a configuration other than the air purge configuration or the mixing configuration, the shut-off plunger 438 can be moved axially to the extended position. As noted above, when the shut-off plunger 438 is in this position, it provides a barrier to water moving from the manifold region 424 into the inner channel 422.

In the foregoing eductor 200, 300, 400 embodiments, in order to create a sufficient vacuum sucking effect on the fire suppressant material, it is desirable to provide that the pressurized flow of water through the eductor 200, 300, 400 along the primary water flow path be at least 30 psi, such as 30-80 psi, or at least 40 psi, such as 40-80 psi. A pressure of about 50 psi may give good results.

The present disclosure teaches different eductor 200, 300, 400 embodiments wherein the configuration of the eductor 400 can be changed by actuating one or more valves. It is to be appreciated that the details of the illustrated valve systems are not required for all embodiments. For example, various arrangements of two-way valves can be provided to establish the desired flow paths.

Various examples have been described. Other embodiments within the scope of the present disclosure include methods, such as methods of use, associated with the described embodiments. These and other examples are within the scope of the following claims.

1. An eductor to mix water together with a fire suppressant material, the eductor comprising inner and outer channels that are concentric and a manifold region at a location where the inner and outer channels come together, the eductor comprising a plurality of inlets and an outlet, the plurality of inlets including a water inlet, a fire suppressant material inlet, and an air inlet, the eductor having a mixing configuration, a rinse configuration, and an air purge configuration, the eductor when in the mixing configuration simultaneously has both: i) a primary water flow path extending from the water inlet, through the outer channel, and into the manifold region, and ii) a fire suppressant material flow path extending from the fire suppressant material inlet, through the inner channel, and into the manifold region, the eductor when in the rinse configuration has a secondary water flow path extending from the water inlet, through the inner channel, and into the manifold region, the eductor when in the air purge configuration has an air flow path extending from the air inlet, though the inner channel, and into the manifold region.

2. The eductor of claim 1 wherein the eductor when in the rinse configuration simultaneously has both: a) the primary water flow path extending from the water inlet, through the outer channel, and into the manifold region, and b) the secondary water flow path extending from the water inlet, through the inner channel, and into the manifold region.

3. The eductor of claim 1 wherein the eductor when in the air purge configuration simultaneously has both: a) the primary water flow path extending from the water inlet, through the outer channel, and into the manifold region, and b) the air flow path extending from the air inlet, though the inner channel, and into the manifold region.

4. The eductor of claim 1 wherein both the air inlet and the fire suppressant material inlet are closed when the eductor is in the rinse configuration.

5. The eductor of claim 1 wherein the fire suppressant material inlet is closed when the eductor is in the air purge configuration.

6. The eductor of claim 1 wherein the outer channel includes an annular first region and an annular funnel region, the annular funnel region becoming increasingly narrow in moving in a downstream direction until reaching the manifold region.

7. The eductor of claim 1 wherein the eductor has a valve system comprising a first 3-way valve, the first 3-way valve comprising a first valve member that is moveable between first and second positions, the first valve member when in the first position simultaneously: a) provides an open passage for flow from the fire suppressant material inlet to the inner channel, and b) blocks flow from the air inlet to the inner channel, the first valve member when in the second position simultaneously: c) blocks flow from the fire suppressant material inlet to the inner channel, and d) provides an open passage for flow from either the air inlet or the water inlet to the inner channel.

8. The eductor of claim 7 wherein the valve system further comprises a second 3-way valve and a bypass channel extending between the first and second 3-way valves, the second 3-way valve comprising a second valve member that is moveable between first and second positions, the second valve member when in the first position simultaneously: a) provides an open passage for flow from the air inlet to the bypass channel, and b) blocks flow from the water inlet to the bypass channel, the second valve member when in the second position simultaneously: c) provides an open passage for flow from the water inlet to the bypass channel, and d) blocks flow from the air inlet to the bypass channel.

9. The eductor of claim 1 wherein the water inlet is operably coupled with a pump configured to pump water into the eductor through the water inlet, and the fire suppressant material inlet is in communication with a powder feed line extending from a powder hopper located in a float of a fixed-wing aircraft.

10. The eductor of claim 1 wherein the eductor includes a selector valve and a bypass channel, the bypass channel being in fluid communication with the water inlet and extending to the selector valve, the selector valve being adjustable among first, second, and third configurations, the selector valve when in the first configuration is open to the fire suppressant material inlet, the selector valve when in the second configuration is open to the bypass channel, the selector valve when in the third configuration is open to the air inlet.

11. The eductor of claim 10 wherein the outer channel is annular and the inner channel is circular, such that the annular outer channel surrounds the circular inner channel, the eductor includes a primary water feed line extending from the water inlet to the annular outer channel, and the bypass channel branches off from the primary water feed line and extends to the selector valve.

12. The eductor of claim 1 wherein the plurality of inlets includes the water inlet, first and second fire suppressant material inlets, and the air inlet, the eductor including a selector valve and a bypass channel, the bypass channel being in fluid communication with the water inlet and extending to the selector valve, the selector valve being adjustable among first, second, third, and fourth configurations, the selector valve when in the first configuration is open to the first fire suppressant material inlet, the selector valve when in the second configuration is open to the second fire suppressant material inlet, the selector valve when in the third configuration is open to the bypass channel, the selector valve when in the fourth configuration is open to the air inlet.

13. The eductor of claim 12 wherein the first and second fire suppressant material inlets are in communication with two respective powder feed lines extending respectfully from two powder hoppers located respectfully in two floats of a fixed-wing aircraft.

14. The eductor of claim 12 wherein the selector valve comprises a valve member that is moveable among first, second, third, and fourth positions, the valve member when in the first position simultaneously: a) provides an open passage for flow from the first fire suppressant material inlet to the inner channel, and b) blocks flow from the second fire suppressant material inlet, the air inlet, and the bypass channel to the inner channel, the valve member when in the second position simultaneously: c) provides an open passage for flow from the second fire suppressant material inlet to the inner channel, and d) blocks flow from the first fire suppressant material inlet, the air inlet, and the bypass channel to the inner channel, the valve member when in the third position simultaneously: e) provides an open passage for flow from the bypass channel to the inner channel, and f) blocks flow from the first fire suppressant material inlet, the second fire suppressant material inlet, and the air inlet to the inner channel, the valve member when in the fourth position simultaneously: a) provides an open passage for flow from the air inlet to the inner channel, and b) blocks flow from the first fire suppressant material inlet, the second fire suppressant material inlet, and the bypass channel to the inner channel.

15. A fixed-wing firefighting aircraft comprising a fuselage and two floats that allow the aircraft to take-off from and land on bodies of water, the aircraft further comprising a water tank with a door having a closed position and an open position, the door when in the open position is configured to drop contents of the water tank from the aircraft, a first supply of fire suppressant material located in one of the two floats, a first water scoop adjacent to a bottom region of one of the two floats, a first water delivery line extending from the first water scoop to the water tank, an eductor constructed to mix water from the water tank together with fire suppressant material from the first supply of fire suppressant material, a first feed line extending from the first supply of fire suppressant material to the eductor, a second water delivery line extending from the water tank, through the eductor, and back to the water tank, and a pump positioned to move water along the second water delivery line.

16. The fixed-wing firefighting aircraft of claim 15 wherein the water tank has a top end region defining a maximum water line, the eductor being mounted below the maximum water line.

17. The fixed-wing firefighting aircraft of claim 16 wherein the eductor has an outlet in fluid communication with the top end region of the water tank such that water from the tank has an open passage through which water from the water tank can back-stream into the outlet of the eductor.

18. The fixed-wing firefighting aircraft of claim 15 wherein the water tank, the eductor, and the pump are all located within the fuselage.

19. The fixed-wing firefighting aircraft of claim 15 wherein the water tank comprises an agitator positioned to deliver a pressurized stream of water into the water tank when the water tank is already filled with water.

20. The fixed-wing firefighting aircraft of claim 15 further comprising a hydraulic system, the pump being a hydraulic pump connected to the hydraulic system.

21. The fixed-wing firefighting aircraft of claim 15 wherein the first supply of fire suppressant material comprises a first powder hopper.

22. The fixed-wing firefighting aircraft of claim 21 wherein the fuselage has a length of between 20 and 45 feet, each float has an elongated length that is substantially parallel to the length of the fuselage, each float has a leading half and a trailing half, and the first powder hopper is positioned on the leading half of the float in which the first powder hopper is located.

23. The fixed-wing firefighting aircraft of claim 21 wherein the first powder hopper comprises first and second hopper tanks configured to retain respective first and second volumes of powder, the first and second hopper tanks being separated by a hollow intermediate float compartment, an auger conduit extends from the first hopper tank through the hollow intermediate float compartment and to the second hopper tank, and an auger is located in the auger conduit such that, when powder is located in the first hopper tank, rotating the auger conveys powder from the first hopper tank to the second hopper tank.

24. The fixed-wing firefighting aircraft of claim 15 wherein the scoop is a retractable scoop having an extended position and a retracted position, the scoop when in the extended position projects downwardly from the adjacent float bottom region, and the scoop when in the retracted position is housed in a recess of the adjacent float bottom region.

25. The fixed-wing firefighting aircraft of claim 15 further comprising a second supply of fire suppressant material, a second water scoop, a third water delivery line, a second feed line, and a fourth water delivery line, the second supply of fire suppressant material located in a second of the two floats, the second water scoop being located adjacent to a bottom region of the second of the two floats, the third water delivery line extending from the second water scoop to the water tank, the second feed line extending from the second supply of fire suppressant material to the eductor, the fourth water delivery line extending from the water tank, through the eductor, and back to the water tank, the pump positioned to move water along the fourth water delivery line.

26. An eductor to mix water together with a firefighting fire suppressant material, the eductor comprising inner and outer channels that are concentric and a manifold region at a location where the inner and outer channels come together, the eductor comprising a plurality of inlets and an outlet, the plurality of inlets including a fire suppressant material inlet, a water inlet, and an air inlet, the eductor comprising an inner tube and an outer tube, the inner tube bounding the inner channel, the outer channel being an annular channel located between the outer tube and the inner tube, the eductor further comprising a shut-off plunger mounted to move axially within the inner channel between a retracted position and an extended position, the shut-off plunger having a leading end region with a blocker head, the blocker head configured such that when the shut-off plunger is in the extended position the blocker head provides a barrier to water moving from the manifold region into the inner tube.

27. The eductor of claim 26 wherein the blocker head of the shut-off plunger is sized to block substantially an entire diameter of the inner channel.

28. The eductor of claim 26 wherein the inner tube has a proximal end and a distal end, the distal end terminating at the manifold region, the shut-off plunger when in the retracted position has its blocker head positioned adjacent to the proximal end, and the shut-off plunger when in the extended position has its blocker head positioned within the inner tube and adjacent to the distal end.

29. The eductor of claim 26 wherein the eductor has a mixing configuration and an air purge configuration, the eductor when in the mixing configuration simultaneously has both: i) a primary water flow path extending from the water inlet, through the outer channel, and into the manifold region, and ii) a fire suppressant material flow path extending from the fire suppressant material inlet, through the inner channel, and into the manifold region, the eductor when in the air purge configuration simultaneously has both: a) the primary water flow path extending from the water inlet, through the outer channel, and into the manifold region, and b) an air flow path extending from the air inlet, though the inner channel, and into the manifold region.

30. The eductor of claim 26 wherein the air inlet is closed when the eductor is in the mixing configuration, and the fire suppressant material inlet is closed when the eductor is in the air purge configuration.

31. The eductor of claim 30 wherein the eductor has a valve system comprising a 3-way valve, the 3-way valve comprising a valve member that is moveable between first and second positions, the valve member when in the first position simultaneously: a) provides an open passage for flow from the fire suppressant material inlet to the inner channel, and b) blocks flow from the air inlet to the inner channel, the first valve member when in the second position simultaneously: c) blocks flow from the fire suppressant material inlet to the inner channel, and d) provides an open passage for flow from the air inlet to the inner channel.

32. The eductor of claim 26 wherein the water inlet is operably coupled with a pump configured to pump water into the eductor through the water inlet, and the fire suppressant material inlet is in communication with a powder feed line extending from a powder hopper located in a float of a fixed-wing aircraft.

33. The eductor of claim 26 wherein the eductor comprises a housing that is elongated along a longitudinal axis, wherein the water inlet intersects the housing at an angle orthogonal to the longitudinal axis, the eductor having an input line through which fire suppressant material can be delivered to the inner channel, the input line extending along an axis that is offset from the longitudinal axis by an acute angle, such that the input line intersects the inner channel at said acute angle.
